(19) United States
(12) Patent Application Publication
(10) Pub. No.: US 2006/0167790 A1
(43) Pub. Date: Jul. 27, 2006

(54) Method and system for transmitting real-time or near real-time price and/or product information to consumers and for facilitating optional fulfillment and optional, automated, real-time or near real-time reverse auctions through wireless or wireline communications devices

(76) Inventors: David A. Gould, New York, NY (US); Alec P. Karys, Framingham, MA (US)

Correspondence Address: Glen J. Gesicki;Suite 2600, 333 West Wacker Drive, Chicago, IL, 60606, US

(21) Appl. No.: 11/340,046

(22) Filed: Jan. 26, 2006

Related U.S. Application Data
(60) Provisional application No. 60/647,363, filed on Jan. 26, 2005.
(60) Provisional application No. 60/726,664, filed on Oct. 14, 2005.

(51) Int. Cl. G06Q 40/00

(52) U.S. Cl. 705/37

(57) ABSTRACT

A method for conducting a reverse auction is disclosed. The method includes the steps of (a) receiving, from a potential purchaser using a communications device, a reverse auction request for a product and/or service that contains descriptive information about the product and/or service; (b) conducting a reverse auction by querying one or more bidder database servers using the descriptive information about the product and/or service, receiving one or more bids to sell the product and/or service from the one or more bidder database servers, and (c) transmitting the one or more bids via the communications network to the communications device. A system to implement the method is also disclosed.

### CROSS-REFERENCE TO RELATED APPLICATIONS

The present application relates to and derives priority from U.S. Provisional Patent Application No. 60/647,363, filed Jan. 26, 2005, entitled, “A Method and System for Transmitting Real-Time or Near Real Time Price Comparison and/or Product Information to Potential Consumers and Also Facilitating Real-Time or Near Real-Time “Reverse Auctions”, Purchase, Payment and Fulfillment Alternatives,” and U.S. Provisional Patent Application No. 60/726,664, filed Oct. 14, 2005, entitled, “Method and System for Hosting Automated, Real-Time or Near Real-Time Reverse Auctions Through Wireless or Wireline Communications Devices,” both of which are hereby incorporated by reference in their entireties.

### BACKGROUND OF THE INVENTION

Whereas regular auctions are typically characterized by one seller and many buyers, reverse auctions are the opposite and are typically characterized by one buyer and many sellers. Historically, reverse auctions have been used by corporations as buyers seeking to optimize competitive bids (usually price) from potential suppliers and/or vendors as bidders pursuant to bid parameters that are defined by the buyer prior to initiating the auction. The present invention breaks with the past in that it uses reverse auctions to empower potential purchasers seeking to minimize their purchase price for many different goods and services. Moreover, the mass adoption of cell phones, smart phones, personal digital assistants, and other handheld electronic devices (collectively “wireless devices”) and the concurrent deployment of high speed wireless networks that connects such wireless devices affords a unique opportunity. By using wireless devices to initiate real time reverse auctions and by providing a system to conduct such reverse auctions, potential purchasers can effect the conversion of retailers into vendors who literally compete for their business. Because the vast majority of retail sales occur in stores and not online (according to U.S. government estimates, more than 95% of 2004 retail sales occurred in stores as opposed to online or through catalogues), the potential market size is significant.

### SUMMARY OF THE INVENTION

The present invention provides an end-to-end shopping, fulfillment, and reverse auction method and system that facilitates (i) the transfer of real-time or near real-time pricing and/or other product related information to consumers and shoppers coupled to a process and methodology that facilitates, at the consumer discretion, (ii) a real-time or near real-time reverse auction process wherein participating sellers can bid for the right to sell such product to such consumer, and/or (iii) the subsequent remote ordering and purchasing of such product for which pricing related information has been received pursuant to either (i) or (ii) above by enabling such consumers and shoppers to conveniently and swiftly transmit or convey their relevant purchase information such as shipping and billing information, or by using pre-stored shipping and billing information.

This process is designed to empower consumers with real time price comparison and other product information as well as purchasing and fulfillment alternatives, including an option to host reverse auctions, thereby facilitating more efficient, cost-effective, and productive purchasing decisions. The process is optimized for delivery through cell phones, personal digital assistants, wireless computers, and other wireless devices, thus enabling potential purchasers who are actually located in or near traditional ‘brick and mortar’ store environments to receive such real time information where, heretofore, access to such competitive information and shopping alternatives has been difficult or non existent. With a method and system in accordance with the present invention, wireless device toting potential purchasers who are actually located in or near traditional, ‘brick and mortar’ based retailers (retailers occupying actual physical retail space), can not only use their wireless devices to access real-time price comparison and fulfillment services, they can also use such wireless devices to initiate a real-time or near real-time reverse auction. The process can also be used on any personal computer connected to the Internet as well. The net effect is dramatic and powerful in that the present invention can alter and redefine the relative power dynamics of the traditional retail marketplace.

The process works when a consumer uses his/her computer or wireless device to input and transmit some or all of the relevant metadata or descriptive information relating to the product in question (UPC, manufacturer name, model name, model number, price, etc). The transmitted metadata is then used to conduct a query which has been optimized to seek out product features or competitive and ideally more attractive prices for the same product as might be advertised by other internet and/or competing retailers or suppliers. The query results are then appropriately formatted for transmission back to the waiting consumer in real or near real-time. Subsequent to the receipt of such data, the customer can then elect to (i) use such data in an attempt to negotiate a better price from the retail store in which he or she may be located, or (ii) can further use the system to (a) initiate a reverse auction for such product or (b) purchase such product outright. In the event the customer chooses option (a), the system would initiate and conduct a reverse auction as described more fully below. Insofar as the customer chooses option (b) above, the reverse auction process would be bypassed and the customer would be prompted to input and transmit his/her relevant purchase information.

One aspect of the invention is a method and system that facilitates real-time or near real-time reverse auctions wherein a potential purchaser who is seeking to purchase a good or service solicits bids from multiple sellers who, by virtue of the reverse auction, compete to sell said good or service to such potential purchaser. The method and system have been designed to empower consumers who historically have not had access to the power of reverse auctions. The method and system are optimized for utilization through cell phones, personal digital assistants, wireless computers, and other wireless devices as well as any personal computer or other wireline device connected to the internet. Optimizing the system for utilization through wireless devices enables consumers who are actually located in or near traditional ‘brick and mortar’ store environments to access the method and system in an environment where heretofore, access to such competitive information and shopping alternatives has been difficult or non existent. The net result is a method and system that delivers a real-time or near real-time, scalable, reliable, efficient, secure, and cost-effective shopping tool.

The reverse auction functionality of the present invention enables a potential purchaser to input and transmit a reverse auction request containing descriptive information about a product or service to the system. The potential purchaser may input the information necessary to initiate a reverse auction, e.g., by using a reverse auction interface residing on his/her computer or wireless device. The system would then use such transmitted data to process the auction request, compile bid results, and transmit said results back to the waiting potential purchaser.

Because the method and system are optimized for use by consumers using their own communications devices, the system should be robust, scalable, reliable, and secure—the system should be able to accommodate hundreds or thousands of simultaneous auctions. As part of this process, the system should provide for intelligent automated responses on the part of the bidders. Although bidders could or might allocate sufficient resources to respond to auction requests on a manual basis in accordance with the present invention, mass acceptance on the part of bidders and scalability suggest an automated solution.

It is important to note that the present invention allows the potential purchaser many ways to identify a product or service for which he/she desires to purchase via reverse auction. For example, the potential purchaser might have identified the product or service simply by visiting a retail store, by browsing on the internet at home (perhaps using shopping engines such as PriceGrabber or agents) using a personal computer with a wireless or wireline Internet connection, or through a wireless device. The potential purchaser may also identify a product or service using a price comparison query in accordance with the present invention. For example, the potential purchaser can use a cell phone to identify a product or service using the shopping agent as described herein by specifying a make or model number, bar code number, or some other unique attribute that allowed the shopping agent to perform a system lookup and thus return the best price for the product or service in question.

It is understood that the term “potential purchaser” as used herein and in the appended claims is synonymous with similar terms such as “customer,” “consumer,” “shopper,” or any term referring to any person or party seeking to purchase products or services using the methods or system of the present invention.

### BRIEF DESCRIPTION OF THE DRAWINGS

FIG. 1 illustrates a workflow using a method in accordance with the present invention.

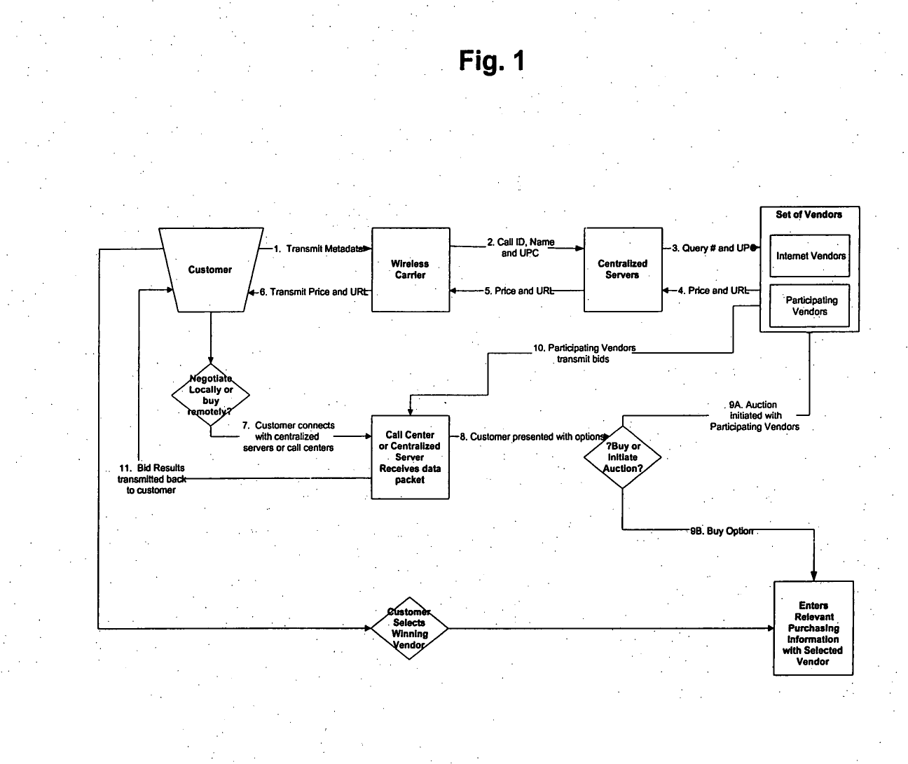

FIG. 2 is a diagram of a system in accordance with the present invention showing connections to customer communications devices and merchant servers.

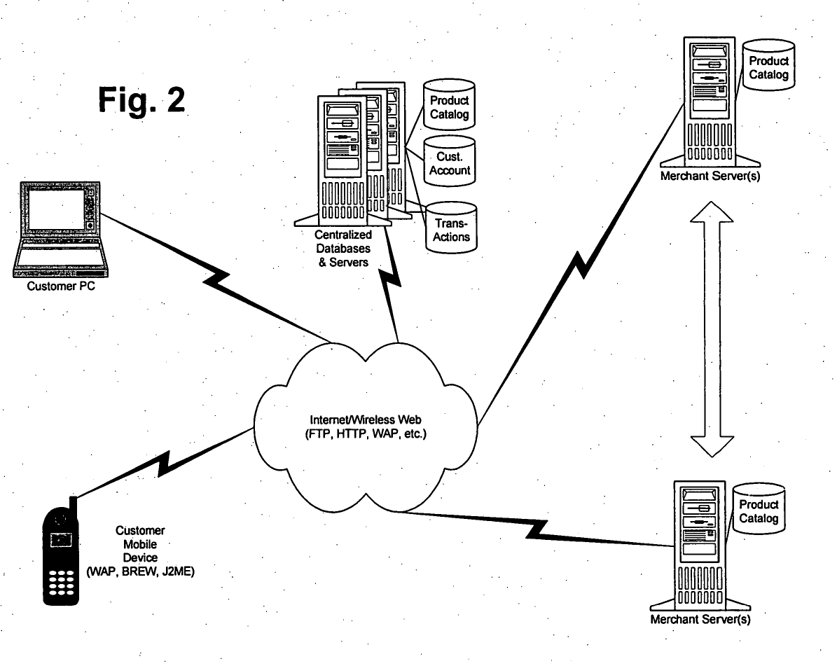

FIG. 3 presents an illustration of a customer user interface in accordance with the present invention.

FIG. 3a presents an illustration of one embodiment of a cell phone based customer user interface in accordance with the present invention that enables a customer to enter descriptive information based on make and model number.

FIG. 3b presents an illustration of one embodiment of a cell phone based customer user interface in accordance with the present invention that enables a customer to enter descriptive information based on bar code number.

FIG. 4 presents an illustration of one embodiment of a cell phone based customer user interface in accordance with the present invention that enables a customer to select amongst different data entry methods.

FIG. 5 presents an illustration of one embodiment of a customer user interface in accordance with the present invention that enables a customer to order a product.

FIG. 6 presents an illustration of one embodiment of a reverse auction interface in accordance with the present invention.

FIG. 7 presents an illustration of one embodiment of a bidder interface in accordance with the present invention.

FIG. 8 illustrates a workflow for a reverse auction in accordance with the present invention.

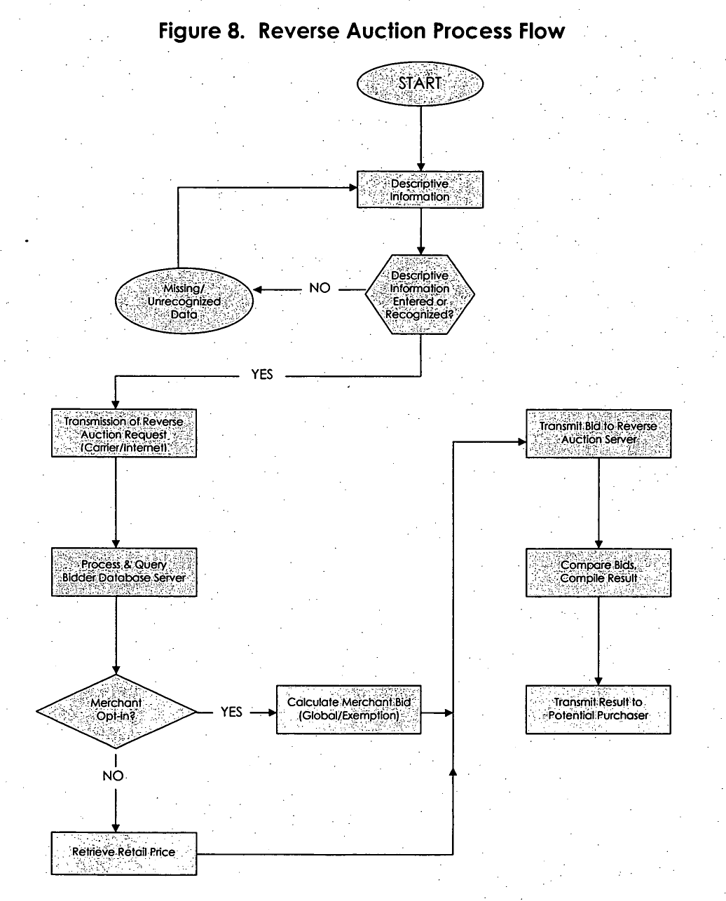

FIG. 9 presents an illustration of an embodiment of a system for conducting a reverse auction in accordance with the present invention showing connections to customer communications devices and back-end merchant servers.

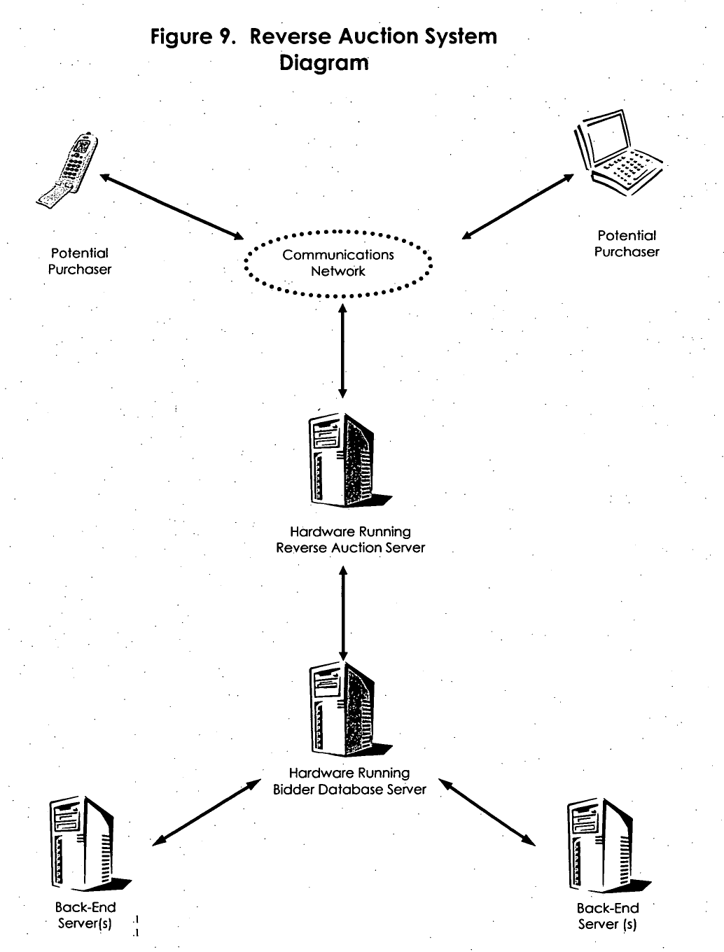

FIG. 10 presents an illustration of one embodiment of a confirmation screen that confirms customer purchase information as well as confirmation of a charitable donation.

FIG. 11 presents an illustration of one embodiment of a user interface screen wherein users can input an email address to which query results are sent.

FIG. 12 presents an illustration of one embodiment of a confirmation screen that details three of the top query results and also confirms the transmission of an email to the selected email address.

### DETAILED DESCRIPTION OF THE INVENTION

The drawings, examples, and preferred embodiments provided herewith and herein are intended to illustrate, in a non-limiting fashion, the best mode presently contemplated of practicing the present invention.

The system utilizes a customer user interface and several main components, including centralized databases and servers, price comparison engines, ordering and fulfillment, and customer tracking, auditing and accounting modules. A system in accordance with the present invention should be highly flexible to accommodate the differing needs of potential purchasers, merchants, and bidders. System components can be hardware agnostic, allowing for the interchangeability of the computer hardware on which the server software, preferably Apache, runs. Some or all of the components of the system may reside in the same physical location, even on the same computer hardware, or may be located in separate physical locations.

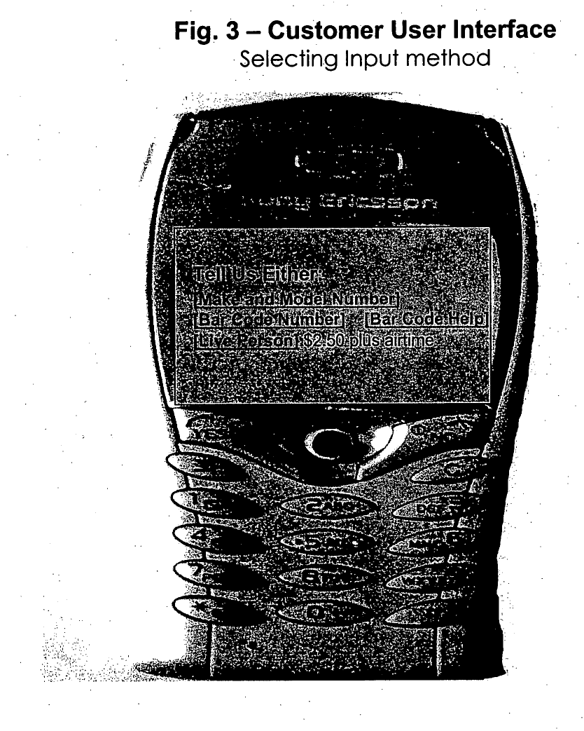

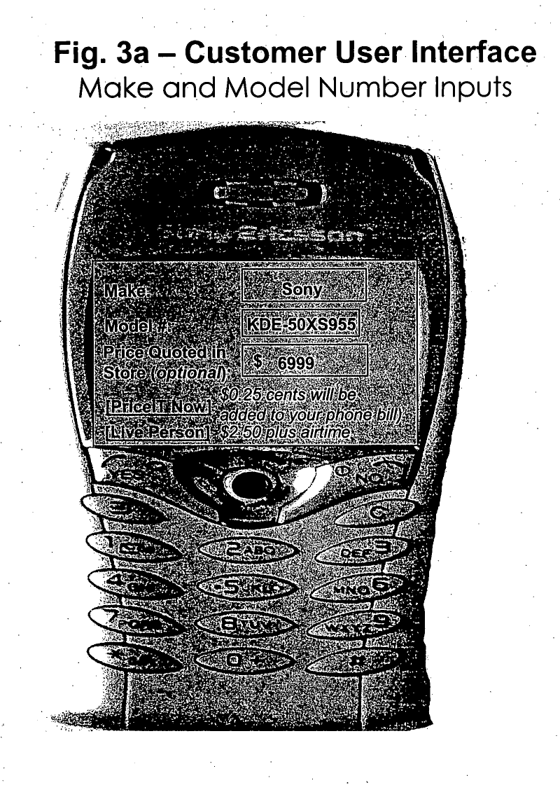

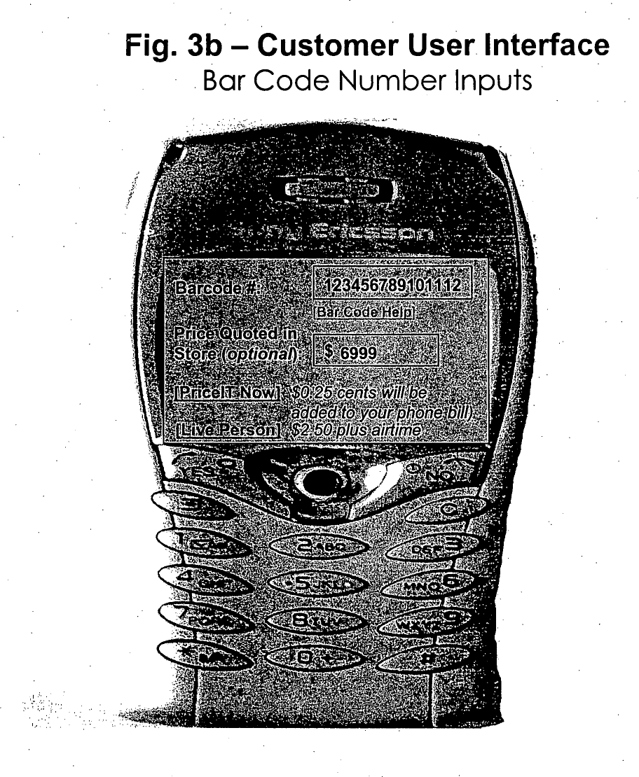

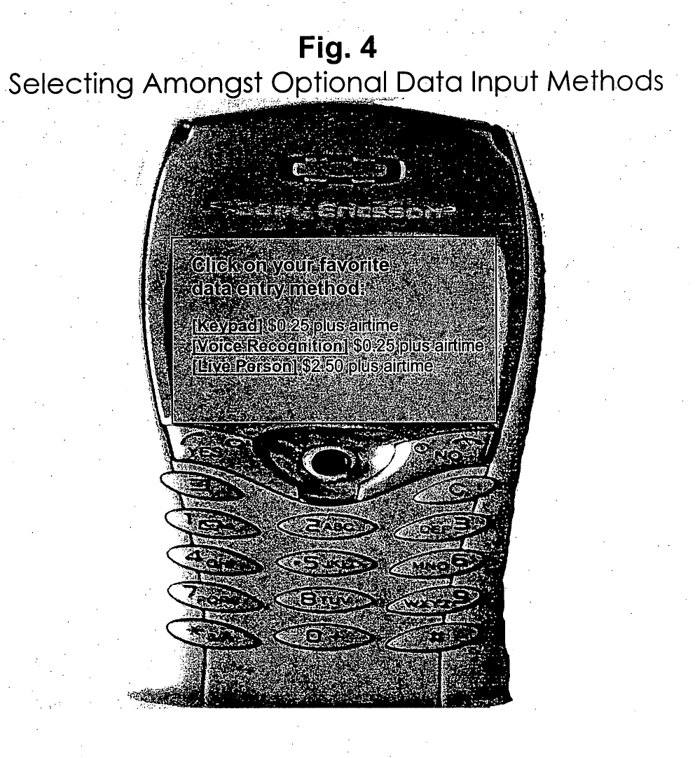

The customer user interface can be a menu-driven interface located on the customer's communications device, such as a data-enabled Motorola T720 cell phone, that facilitates input of the descriptive information relating to the product and/or service (“metadata”) the customer is interested in buying. The customer user interface can be written in any suitable programming language; WAP/WML, J2ME, or BREW are preferred examples. This metadata may include the product's UPC number, manufacturer name, model name and/or model number, price, or such other descriptive information that can be used to uniquely identify the product or service in question for which the customer desires to retrieve such real time price or product information. (See FIG. 3a and FIG. 3b) Metadata input can be effectuated with a standard cell phone keyboard, a QWERTY compatible keyboard, or using existing interactive voice recognition (IVR) technologies. Product metadata can also be simply transmitted via a standard phone call which may be answered by automated or manned systems (for example, a call center). (See FIG. 4)

In another aspect of the present invention, the descriptive information about the product and/or service is entered through an optical character recognition (OCR) extrapolator. A benefit of the use of OCR is that an electronic form with data fields as described above is not necessary. For example, a potential purchaser using a cell phone equipped with a digital camera can take a picture of the bar code number on a product's packaging; the OCR extrapolator can then extrapolate the bar code number from the digital image and include the number in the descriptive information about the product.

In further aspects of the present invention optimized for potential purchasers using telephones, the potential purchaser can use a keypad on a communications device (i.e., DTMF) to input the descriptive information about the product and/or service when formulating the product or service comparison query. The potential purchaser can also use speech IVR (interactive voice response) to input the descriptive information about the product and/or service. For example, the potential purchaser can be provided with a speech IVR customer user interface that prompts the potential purchaser for descriptive information. In a preferred embodiment, the speech IVR customer user interface is written in VoiceXML or SALT and uses Microsoft Speech Server software residing on industry standard server hardware based on Intel architecture. In another example, the potential purchaser can use the keypad on a mobile phone to compose a text message containing the descriptive information about the product and/or service, which can be sent as the query. Furthermore, the descriptive information about a product or service can be inputted into the query using automatic speech recognition (ASR), such as that provided by Nuance, Inc. In such a case, a telephone caller can use his/her own voice to speak the descriptive information about a product and/or service to supplement or obviate the use of a keypad. There are many benefits to using ASR with the system and method of the present invention. One benefit is that wireline telephone callers using rotary phones can make full use of the system via ASR without having telephone keys to press. Another benefit is that mobile phone users need not use the keypad to enter descriptive information about a product or service, which saves time and helps avoid spelling errors.

In yet a further aspect of the present invention, the descriptive information about the product and/or service can be entered into the customer user interface using a bar code scanner. Such a feature is beneficial especially where the potential purchaser wishes to compare prices on a single product or service. Similarly, the descriptive information about the product and/or service can be entered into the query by receiving information contained in a radio frequency identification (RFID) tag, which contains the descriptive information about the product and/or service in an electronic form readable by a RFID transceiver. The RFID transceiver that receives the descriptive information about the product and/or service can, for example, be embedded into the potential purchaser's communications device (such as a cell phone) for the greatest ease of use.

In accordance with the present invention, where a customer user interface is used, the customer user interface can accept data input via any and/or all of the above described methods. For example, the customer user interface can allow the potential purchaser to manually enter descriptive information about a product and/or service via keystrokes on a computer keyboard. In such an example, the customer interface can be, e.g., a graphical user interface (GUI) or other such electronic form with data fields into which the potential purchaser can enter the descriptive information about the product and/or service. (See FIG. 3, FIG. 3a, and FIG. 3b)

In yet another aspect of the present invention where a customer user interface is used, the customer user interface is located remotely from the potential purchaser; i.e., is not resident on the potential purchaser's communication device. Such an application is beneficial if, for example, call center assistance is desired. In such a case, the potential purchaser can call the call center and speak with an agent, who inputs the descriptive information about a product or service into the customer user interface based on the potential purchaser's instructions. Also, where the customer user interface is located remotely from the potential purchaser, any of the above-described methods for entering descriptive information about the product and/or service (electronic forms, OCR, ASR, etc.) can be used.

Transmissions to and from the system are carried via a communications link. The communications link can be, without limitation, any existing or future wireless or wireline Internet, wireless or wireline data network, wireless or wireline voice network, or wireless or wireline data or voice technology that can be used to transmit the metadata as inputted by the consumers to the centralized servers and databases. Wireless data can be transmitted using existing cell phone companies as distribution intermediaries. In this case, the communications link would provide for the passing of the metadata from the user's cell phone through the carriers' networks and related systems, and into the centralized servers and databases.

The centralized databases and servers are designed to manage the entire system including receiving the incoming metadata or query from the communications link, processing the query using an appropriate price or product comparison search technology, and handling reverse auction requests. In preferred embodiments, all hardware works with the Linux operating system, the servers use Hewlett-Packard Blade server hardware running Apache server software; and the databases within the centralized databases and servers utilize mySQL database software. The LAMP Framework (Linux, Apache, mySQL, PHP, Python, PERL) is preferably used for application development. Websites hosted on the centralized databases and servers preferably run Microsoft IIS server software. The price or product comparison engine can either use existing Internet based price or product comparison shopping engines (i.e., outsourced comparison engines; PriceGrabber or ShopZilla are preferred examples) or the price or product comparison engine may be a proprietary module. In the case of the former, the system would include a method for transferring appropriately formatted metadata to such outsourced comparison engine and for receiving query results from the same outsourced comparison engine. The transfer of such appropriately formatted metadata to the outsourced comparison engine and the receipt of any price or product comparison data from the outsourced comparison engine may be effected via any existing or future data transmission network, including an electronic data interface, a virtual private network, or the internet, (c) formulating and formatting a response to the query (the “price comparison data result” or “product comparison data result”). Should the query produce only one retailer or supplier, the price or product comparison data result may include a comparison of the supplier's offering price with a price received from the potential purchaser as part of the descriptive information about the product, or simply identify the retailer or supplier without performing a comparison, (d) transmitting the price comparison data result or product comparison data result through the communications link back to the waiting consumer, (e) routing calls and/or data to the ordering and fulfillment system as may be required from time to time, (f) hosting and initiating the reverse auction process as more fully described herein; and (g) tracking, accounting, and customer service data compilation and storage systems.

In response to the price comparison data result, product and/or service comparison data result, or reverse auction result (described below), the customer may decide to purchase the product or service in question from one of the retailer alternatives presented in the price comparison data result, product and/or service comparison data result, or reverse auction result (as opposed to purchasing the product from the retail store in which the consumer may then be located at the time he/she initiated the query or reverse auction). In such instances, the system would provide for the real time or near real time ordering of such product through such alternative retailer or supplier. Any ordering and fulfillment requested by the consumer can be effectuated by prompting the consumer to input all the relevant purchasing information (billing, shipping, etc.), by accessing customer information pre-stored on a customer account database, or by automatically directing such consumer to a remote call center which may then act as an agent to input the same relevant purchasing information on his/her behalf. Where a call center is used, the system can automatically transmit the metadata and vendor or supplier of choice as selected by the consumer to such call center in order to automate and streamline the order process.

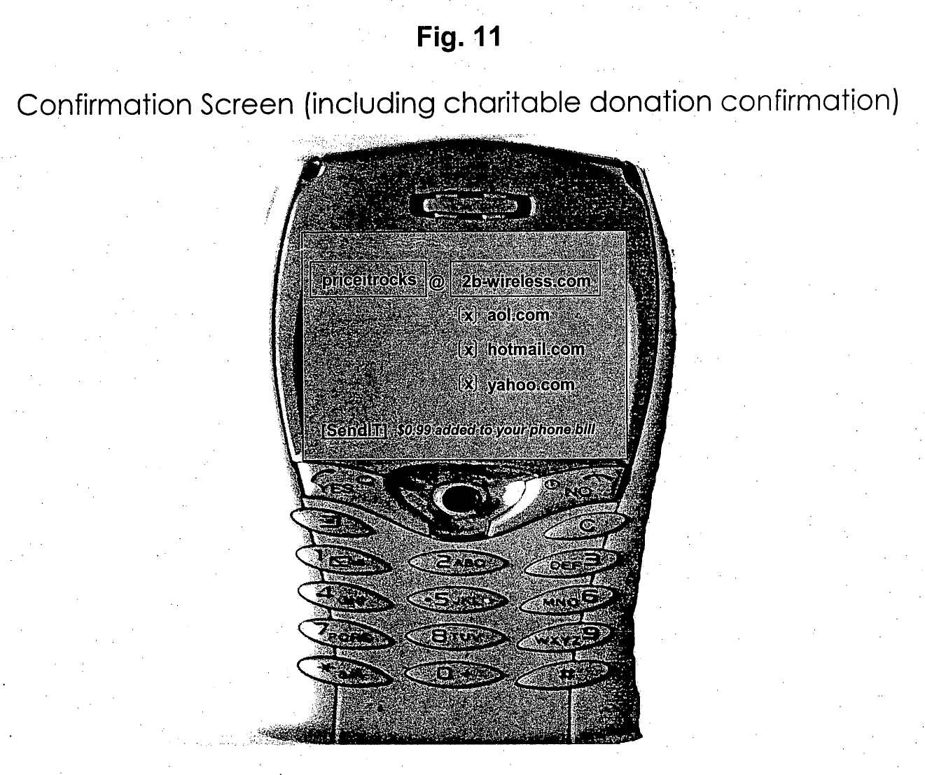

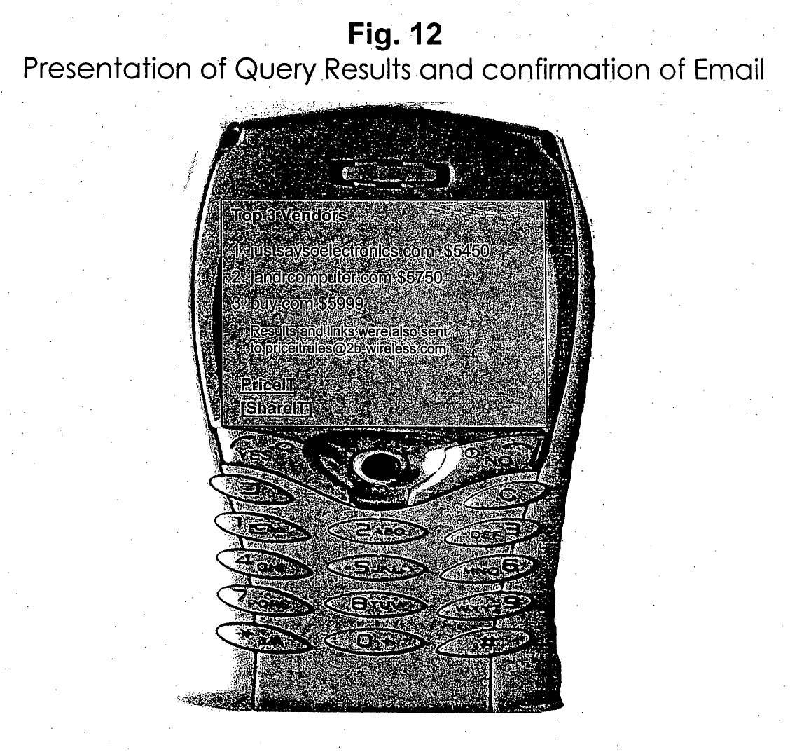

The customer may decide not to purchase a product or service in response to a price or product and/or service comparison data result or reverse auction result. In such a case, the system can give the customer the opportunity to receive information contained within the price or product and/or service comparison result or reverse auction result via SMS and/or e-mail, preferably the top three merchants' prices or bids. The system can prompt the customer to input an SMS or e-mail address or can access a customer account database to determine whether the customer has stored an SMS or e-mail address. The system can then transmit the information to the customer's SMS or e-mail address. (See FIG. 11 and FIG. 12)

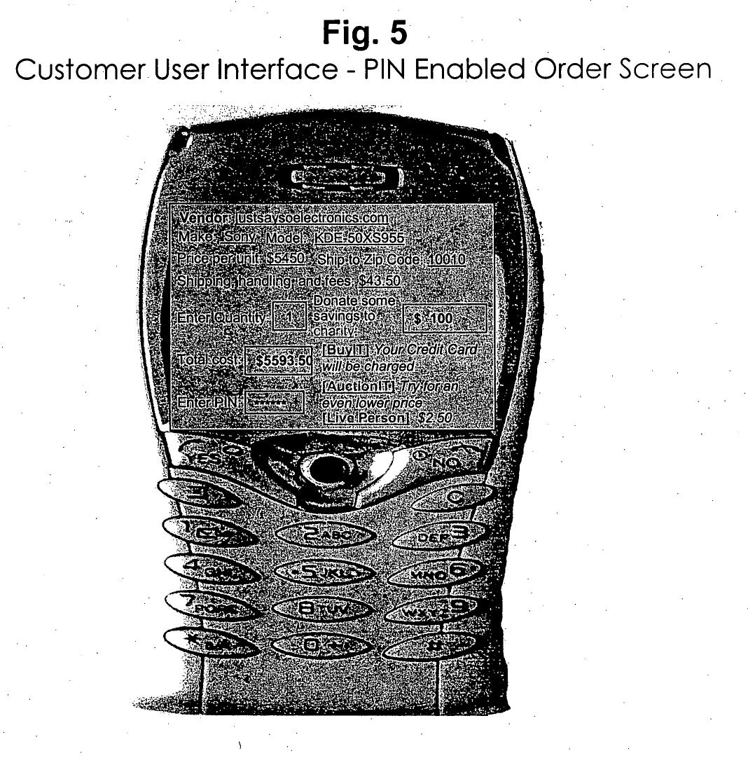

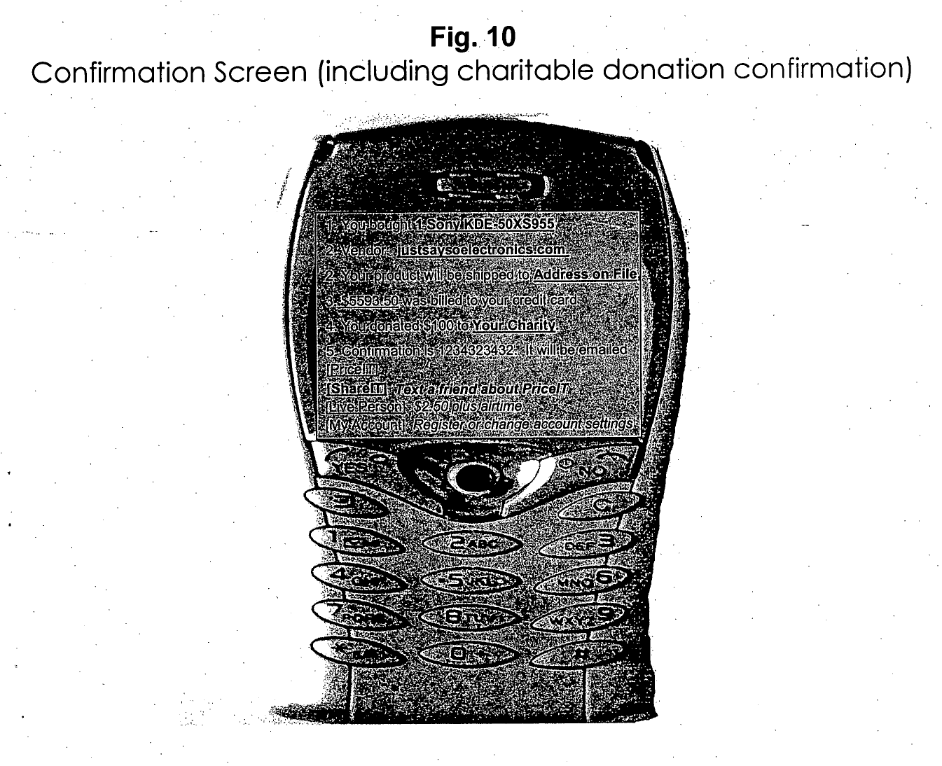

The price or product comparison data result can include the amount of money the customer has saved through conducting a price or product comparison query. The customer can be prompted to donate some or all of the amount saved to one or more of the customer's favorite charities. The system allows the customer to identify and store the one or more favorite charities on a customer account database. When the customer donates an amount of savings to a charity, the system transmits the information necessary to effect the donation (such as a credit card number) to the charity and also transmits a donation confirmation to the customer's communications device. (See FIG. 5 and FIG. 10)

The system can include one or more product catalog database(s), which store information relating to products and/or services and are searched in response to a customer query. The product catalog database(s) may reside along with other components of the centralized databases and servers or be located remote from them. Where the product catalog database resides within the centralized databases and servers, the information relating to products and/or services can be populated and/or updated via an automatic process, wherein the system accesses merchant databases or websites and downloads information from them. Populating or updating the product catalog database(s) is done preferably through an automatic ftp or http datafeed from the merchant databases and/or through a web crawler that searches merchant databases or websites on a predetermined list for product and/or service information. The result is a near-real time product catalog database. The system can also obtain information relating to products and/or services directly from merchant databases in response to a customer query.

As stated above, the system can include a customer account database that stores information relating to customers using the system. Users can register information in advance, preferably via a registration process at a predefined website, into the customer account database so that the purchasing process can be further streamlined. Information stored on the customer account database can include, for example, names, nicknames, mailing addresses, telephone numbers, e-mail addresses, websites, credit card information, shipping information, billing information, favorite charities, and any other customer information desired. The system will store such information so that repeat users can quickly effectuate future purchases. This information can be accessed and/or protected by a personal identification number (PIN), security code, or other personal identifier established at the time of registration. (See FIG. 5)

The system can include a transaction database, which stores information relating to all transactions customers have carried out using the system. Information stored on the transaction database can include the product and/or service that was the subject of a price or product and/or service comparison or reverse auction, the date and time of each price or product and/or service comparison carried out, the date and time of each reverse auction carried out, the result of each price or product and/or service comparison and reverse auction, the amount saved in each transaction, the amount donated from the savings in a transaction (if any), and any other information regarding any transaction carried out by users of the system.

As stated above, the customer may decide to initiate a reverse auction amongst competing retailers or suppliers instead of buying a product or service outright. The method and system of the present invention allows the customer to use his/her computer or wireless device to initiate such reverse auction amongst participating retailers or suppliers by sending an inquiry to the system, which processes the inquiry and routes it to participating retailers or suppliers. Those participating retailers or suppliers that elect to respond to the inquiry will then transmit their best price bids back to the system, preferably in an automated fashion. The system automatically processes bids received from those participating retailers or suppliers for transmission back to the waiting customer. The system provides for participating retailers or suppliers to have an automated process for responding to such inquiries so as to accommodate potentially high transaction volumes on a timely and cost effective manner. The system could use either fully automated or semi-automated systems augmented by staffed call centers to administrate such reverse auctions and to route the flow of all data between the customer and such participating retailers or suppliers.

The customer may decide, subsequent to the conclusion of the reverse auction, to purchase the product in question from one of the participating retailers or suppliers who submitted a bid (as opposed to purchasing the product from the retail store in which the consumer may then be located at the time he/she initiated the reverse auction). In such instances, the system would provide for the real-time or near real-time ordering of such product through such retailer or supplier. Any ordering and fulfillment requested by the consumer can be effectuated by prompting the consumer to input all the relevant purchasing information (billing, shipping, etc.), or preferably to use pre-stored billing and shipping information by recalling pre-stored customer information stored on the system as described above, or by automatically directing such consumer to a remote call center which may then act as an agent to input the same relevant purchasing information on his/her behalf. In such instance, the system may automatically transmit the metadata and vendor or supplier of choice as selected by the consumer to such call center in order to automate and streamline the order process.

The reverse auction process can be thought of as being comprised of four distinct phases: initiation, response, transmission, and control. As such, the method and system of the present invention can accommodate the different phases of a reverse auction as follows:

Initiation. The method and system or the present invention enables a potential purchaser to initiate a reverse auction through his/her communications device.

Response. The method and system allows bidders to respond to any reverse auction request (as defined hereinafter) transmitted to the system by a potential purchaser.

Transmission. The method and system of the present invention is operative with communications networks that transmit the reverse auction request to the system and then to transmit the bids received from the bidders back to the potential purchaser. In addition, data transmission networks should monitor, format, and route traffic as required by different wireless and/or wireline network operators.

Control/Security. The method and system of the present invention allows for the controlling, tracking, monitoring, and securing of many simultaneous reverse auctions. Potential purchasers can be uniquely identified and/or authenticated along with each of their reverse auction requests, including timestamps and tracking. Bidders can be uniquely identified and/or authenticated, along with each of their responses, along with timestamps and tracking. All transmitted and stored data can be encrypted. A system in accordance with the present invention may be protected with firewalls and the like and administrative access protected by admin userid/password and/or a physical key. Also, other security measures such as virtual private networks (VPNs) may be used.

The reverse auction initiation process begins with the formulation of a request to initiate a reverse auction (“reverse auction request” or “auction request”). In the reverse auction request, the potential purchaser enters descriptive information about the product and/or service that the potential purchaser is interested in buying. The descriptive information is used to identify the unique product and/or service that the potential purchaser wishes to buy; the descriptive information can also be used to identify a type of product and/or service that the potential purchaser is interested in buying. This descriptive information can include, for example, a unique product and/or service identifier (a name, make, model number, bar code number, etc.), price, price to be beat, color, quantity, and/or quality attributes, as well as the potential purchaser's or bidder's location or zip code, or any other product and/or service identifier.

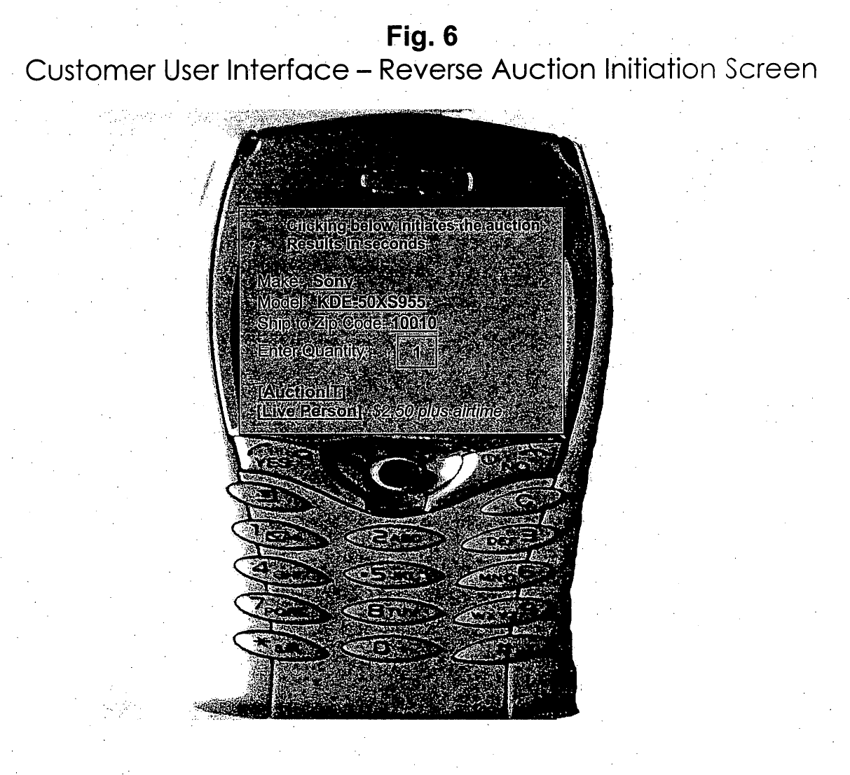

In an embodiment of the present invention, the potential purchaser enters the descriptive information about the product and/or service through a software application interface (the “reverse auction interface”) that may be resident on the potential purchaser's communications device or may be located remote from the potential purchaser's communications device. The purpose of the reverse auction interface is to allow the potential purchaser an intuitive, facile way to input descriptive information about a product or service such as a unique product or service identifier (a name, make, model number, bar code number, etc.), price, price to be beat, color, quantity, quality attributes, the potential purchaser's or bidder's location or zip code, etc. pursuant to which the bidders can respond. (See FIG. 6) In one scenario, a consumer might be using a cell-phone based shopping service. In this instance, the consumer has used a price comparison or shopping service (such as the shopping, fulfillment, and reverse auction agent described above) to previously enter the descriptive information about a product and/or service that he/she wishes to submit for reverse auction. (See FIG. 3a and FIG. 3b)

In one aspect of the present invention, where the potential purchaser has used a price comparison or shopping service to previously enter the descriptive information about a product or service, the previously entered descriptive information about a product or service is incorporated into the reverse auction request. Where the potential purchaser is using a reverse auction interface, such data can be imported into the reverse auction interface. Alternately, the descriptive information about the product and/or service can be entered into the reverse auction request through any of the methods set forth above for conducting a price or product and/or service comparison query (e.g., GUI, OCR, DTMF, IVR/ASR, bar code scanner, RFID, etc.).

Although reverse auctions can be used to accommodate competitive bids based on a variety of descriptive information about a product or service, it is expected that reverse auctions based on descriptive information about a product or service's price will be the most significant and most common. However, reverse auctions in accordance with the present invention can be conducted based on other criteria such as quantity, qualitative attributes, the proximity of the potential purchaser to the bidders, among others. For example, a potential purchaser interested in purchasing a large volume of goods may wish to conduct a reverse auction based on a bidder's ability to provide the potential purchaser with the largest quantity of the desired item.

Subsequent to the potential purchaser providing descriptive information about a product or service, the potential purchaser initiates the reverse auction. On a cell phone, for example, this can be accomplished by hitting standard software “Send” buttons on the screen. Such an action results in the transmission of the descriptive information about a product or service contained within the reverse auction request, in formats that are appropriate for secure transmission across the appropriate network, to the system for processing by a reverse auction server. Where a potential purchaser is using a personal computer, the reverse auction can be initiated by, for example, clicking a standard “Send” button on the screen that sends a reverse auction request as an e-mail containing the descriptive information about the product and/or service.

Because of the potential high volume of reverse auction requests, it is desirable that bidders would not be required to allocate human resources to respond to reverse auction requests on a manual, case by case basis. The present invention addresses this need by providing a bidder interface configured to allow bidders to input and/or edit bid parameters, some of which are detailed below. Using such a bidder interface, a bidder can respond to any query based on a reverse auction request on an automated basis pursuant to parameters that are predetermined by the bidders using the bidder interface. Allowing bidders to predetermine the various bid parameters enables bidders to automatically generate bids in response to queries based on reverse auction requests without human involvement, with the attendant benefit of efficiency.

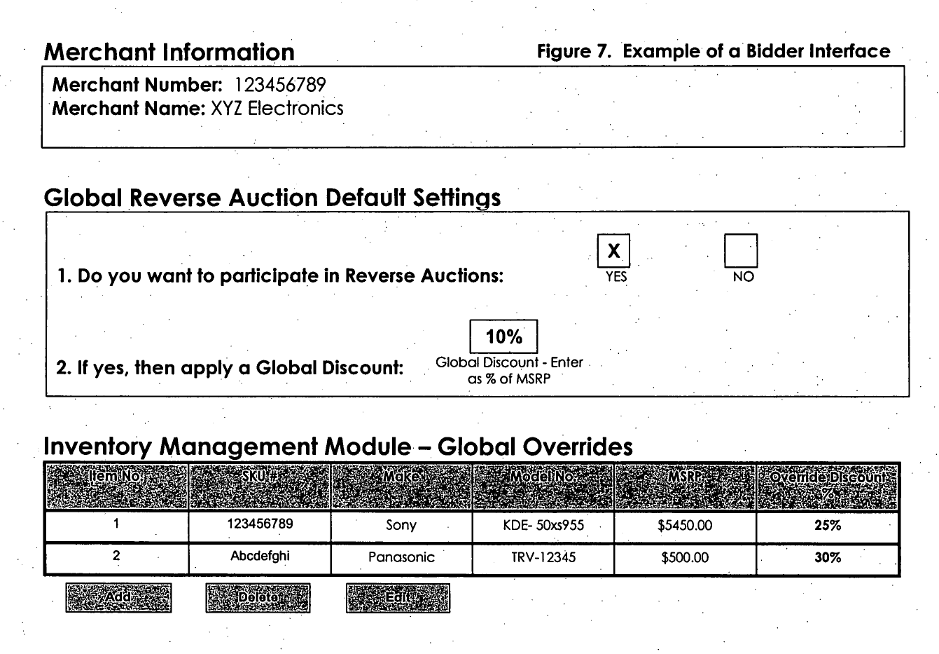

Like the reverse auction interface described above, the bidder interface may be a GUI or other such electronic form containing several data fields. Any number of fields is possible; several examples follow. One is a simple on/off “Opt In Toggle.” While many bidders might be interested in registering with generic shopping services, search engines, or price comparison engines, they may not wish to participate in reverse auctions for a whole host of reasons. The Opt In Toggle accommodates this need quickly. A second field, “Global Bid Default”, works in conjunction with the Opt In Toggle field. For those bidders who decide to opt in to the reverse auction system, the Global Bid Default field is used to define a global discount that can be applied to every one of the bidder's products or services or to preselected items or groups of items in the bidder's database(s). The Global Bid Default can be specified in terms of a specific currency amount or as a percentage of price. A third is “Category Default”, which provides a pre-determined discount by category. A fourth is a “Discount By SKU” field, which provides individual discounts based on a stock keeping unit (SKU). A fifth provides for further discounts based on volume of orders over a specified period of time, by SKU. Any of the above fields may be removed or other fields may be added to accommodate the bidder's needs. (See FIG. 7)

In other aspects of the present invention, the bidder interface can allow bidders to enter bid parameters using OCR and/or ASR. Therefore, to use an example of an OCR bidder interface, a bidder is enabled to provide bid parameters to the bidder database server by simply composing an e-mail or a text message containing those parameters. In the case of ASR, bidders can set bid parameters by speaking those bid parameters into an ASR bidder interface using, for example, a wireless or wireline phone. These embodiments are analogous to the OCR and ASR input methods set forth above and provide many of the same benefits to bidders who cannot conveniently use a bidder interface as an electronic form or GUI.

In accordance with the present invention, a bidder can choose to forego the advantages of automated bid generation and choose to assign a person to receive queries and generate bids in response to those queries in real time. In such an embodiment, a bidder interface is not necessary but may still be used.

The reverse auction functionality of the present invention is a powerful inventory management and data collection tool for bidders who opt into the system. For example, suppose that one particular bidder is sitting on a large inventory of a particular product and, as a result, desires to aggressively discount said product so as to quickly liquidate his inventory. It would be helpful if such bidder could apply a specific discount against this one product type without offering similar discounts against all the other products in his inventory. To this end, the bidder interface provides this flexibility by allowing the bidder to identify, add, or delete specific particular products to an exemption field such that a different discount other than the Global Bid Default would apply against the particular product in question. (See FIG. 7)

The present invention is operative with communications networks that can be used to transmit the reverse auction request to a reverse auction server. Subsequent to the reverse auction server's processing of the auction request, and the receipt of bid(s) in response to that request, the reverse auction server appropriately formats the bids and transmits them to the potential purchaser's communications device. For example, in one preferred embodiment of the present invention, wireless data would be transmitted using existing cell phone companies as distribution intermediaries. In such an example, the communications network would be a wireless telephone network that would provide for the passing of the reverse auction request from the user's cell phone through the carriers' networks and related systems, and on to the reverse auction server. Once one or more bids are received, the communications network would provide for the passing of the bid(s) from the reverse auction server to the user's cell phone. While a preferred embodiment of the present invention is optimized for use through wireless devices, the communications network can be, without limitation, any wireless or wireline Internet network, wireless or wireline data network, wireless or wireline voice network, or wireless or wireline data or voice technology.

A method and system in accordance with the present invention should accommodate high volumes of simultaneous reverse auctions that can span across many different product categories and subcategories. As such, the method and system should be able to accommodate the needs of high volumes of authenticated consumers who might initiate many simultaneous, distinct reverse auctions. Additionally, the method and system should accommodate the needs of many authenticated potential bidders that similarly span across many product categories and subcategories. As such, an auction hosting and controlling system implements the method of the present invention.

The logic and work flows associated with the method for conducting a reverse auction in accordance with the present invention are as follows:

1. The reverse auction server receives a reverse auction request containing descriptive information about a product or service as described above from a potential purchaser, who initiated the reverse auction request using a reverse auction interface to a reverse auction server for processing.

2. The reverse auction server processes the auction request by interpreting the descriptive information about the product and/or service contained within the reverse auction request and transmits a query to one or more bidder database servers based on the descriptive information about a product or service contained within the reverse auction request.

3. A bidder database server then receives the query transmitted by the reverse auction server. A bidder database server may host a bidder interface that allows a bidder to predetermine any number of bid parameters and generate automatic bids as described above.

a. If the bidder receives a query and has decided to opt out of the reverse auction process, no further action is taken. The bidder is deemed to have not submitted a bid.

b. If, however, the bidder database server receives a query from the reverse auction server and the bidder has opted into the reverse auction process, then the bidder database server automatically generates the bidder's bid. In one preferred embodiment where the lowest price is sought by the query sent by the reverse auction server, if the bidder has used the bidder interface to set a Global Bid Default, the bidder database server calculates a bid by deducting the Global Bid Default from the standard price. If the bidder database server receives a query pertaining to a product or service that is included in an exemption field in the bidder interface, then the exemption discount applicable to that exemption field would override the Global Bid Default and be subtracted from the standard price. Any discount applied to generate a bid, whether in the Global Bid Default, an exemption discount, or elsewhere, can be a fixed amount of currency or can be a percentage of the standard price. The automatically generated bid is sent to the reverse auction server.

c. In the case where the bidder chooses not to generate automatic bids but instead has assigned a person to monitor incoming queries, that person can opt out or generate a bid in response to any query.

4. The reverse auction server receives the bid(s) from the bidder database server(s). The reverse auction server can compare the received bids and compile a reverse auction result, which may include all bids received from bidder database servers, some bids, or only the top bid. The compilation of the reverse auction result occurs in real time or near-real time if the bids are automatically generated. However, the reverse auction server can receive late bids for transmission to the potential purchaser.

5. The reverse auction server appropriately formats the bid(s) and transmits them across the appropriate communications network to the potential purchaser's communication device. Where the reverse auction server has compiled a reverse auction result, the reverse auction server appropriately formats the reverse auction result and transmits it across the communications network to the potential purchaser's communications device. Any decision on potential purchaser's part (purchase, send one or more of the bids, or no action) based on the reverse auction result can be fulfilled in the same way as though the potential purchaser had chosen to buy the product or service outright. (See FIG. 12)

From the point of view of the potential purchaser, the method for conducting a reverse auction is as follows:

1. The potential purchaser initiates the reverse auction by (i) composing, on a communications device, a reverse auction request for a product and/or service containing descriptive information about the product and/or service as described above; and (ii) sending the reverse auction request to a system having a reverse auction server, which operates as described above.

2. The potential purchaser receives from the system one or more bids to sell the product and/or service on the communications device. As described above, the potential purchaser can receive the bids in the form of a reverse auction result.

3. The potential purchaser optionally purchases the product and/or service or optionally requests that one or more of the bids be sent to an e-mail address or telephone number.

A system for conducting a reverse auction in accordance with the present invention includes the following components:

Reverse Auction Server. The reverse auction server is a software application running on industry standard computer hardware, preferably with Intel architecture, that is designed to control, process, prioritize, monitor, and route each of the individual auction requests. The reverse auction server receives incoming reverse auction requests from the communications network. The reverse auction server then processes each reverse auction request by interpreting the descriptive information about the product or service included within the reverse auction request and formulating a query. The reverse auction server then queries one or more bidder database servers, which preferably run the mySQL database software, that generate bids based on the query. After receiving bids from the queried bidder database servers, the reverse auction server can optionally compile a reverse auction result containing all of the bids, some of the bids, or the top bid. The reverse auction server then formats the bid(s) or reverse auction result for transmission across the appropriate communications network and transmits the bid(s) or reverse auction result to the potential purchaser's communications device.

Bidder Database Server. The bidder database server is a software application running on computer hardware that receives queries issued by the reverse auction server, searches the descriptions of the bidder's available products or services based on the query, formulates a bid in response to the query, and transmits the bid to the reverse auction server. Preferably, the bidder database server uses mySQL database software running on industry standard computer hardware with Intel architecture. The bidder database server may perform the search by accessing the bidder's back-end databases that contain a catalog of the bidder's products and services in electronic format. The bidder database server also can store and compile, amongst other things, product or service descriptions that may include attributes and metadata, which in turn may include product numbers, make, model number, and price. The bidder database server also may host the bidder interface and compiles the data entered into the bidder interface by the bidder. The present invention allows for the bidder database server to have any physical location. In an embodiment of the present invention, the bidder database server resides on computer hardware having the same physical location as the reverse auction server. Such a configuration advantageously facilitates a rapid, real-time response for the waiting potential purchasers, thus eliminating any lag time associated with querying remotely located bidder database servers. However, in another embodiment of the present invention, it may be more convenient for a bidder to locate the computer hardware on which the bidder database server resides at the bidder's physical location, remote from the hardware running the reverse auction server software. Also, the bidder database server may serve as a presentation point for queries and an entry point for bids in an embodiment where the bidder has a person monitoring incoming queries and generating bids.

Because of the potentially high numbers of simultaneous auctions and participating bidders or potential purchases, each of the above modules should optionally be architected with scalability in mind. Scalability architecture options can include load balancing, such as that available from CISCO, and/or disk clustering, such as that available from Hewlett-Packard.

Reliability. Because of the nature and real time sensitivity of e-commerce transactions, redundancy can be utilized to accommodate fault tolerance, including suspend and resume processes.

Security. All stored and transmitted data can be tracked and encrypted. Multiple layers of security can be further utilized to assure maximum security, including authentication, authorization, and access control, such as those offered by Computer Associates or RSA.

It will be apparent to one of skill in the art that described herein is a novel method and system for transmitting real-time or near real-time price and/or product information to consumers and for facilitating optional fulfillment and optional, automated, real-time or near real-time reverse auctions through wireless or wireline communications devices. While the invention has been described with reference to specific embodiments, it is not limited to those embodiments. The present invention may be modified or varied in many ways and such modifications and variations as would be obvious to one of skill in the art are within he scope and spirit of the invention and are included within the scope of the following claims.

What is claimed is:

1. A method of transmitting real-time or near real-time pricing and/or product or service information to a potential purchaser and facilitating purchase of the product or service by the potential purchaser, comprising the steps of:
(a) receiving descriptive information about the product or service from a potential purchaser over a communications link via a user interface residing on a wireless device;
(b) identifying one or more suppliers offering the product or service for sale;
(c) obtaining pricing and/or product or service information from the supplier(s);
(d) comparing the pricing and/or product or service information obtained from the supplier(s);
(e) generating a price and/or product or service comparison result;
(f) transmitting the price and/or product or service comparison result to the potential purchaser via the communications link for display on the potential purchaser's user interface; and
(g) enabling the potential purchaser to purchase the product or service from any of the suppliers.

2. The method of claim 1, further comprising the steps of:
(a) transmitting one or more options to the potential purchaser via the communications link, including an option to initiate a reverse auction of the product or service and/or an option to purchase the product or service, optionally including an option to transmit some or all of the information contained within the price and/or product or service comparison result to the potential purchaser, and optionally including an option to make a donation; and
(b) optionally receiving a selection of one or more of the options from the potential purchaser via the communications link.

3. The method of claim 2, wherein the potential purchaser has selected the option of initiating a reverse auction, the reverse auction comprising the steps of:
(a) transmitting a request for bids to the supplier(s);
(b) receiving one or more bids from the supplier(s);
(c) transmitting the bid(s) to the potential purchaser via the communications link;
(d) receiving a purchase decision from the potential purchaser via the communications link accepting or declining any of the bids; and
(e) optionally transmitting the purchase decision to the supplier whose bid was accepted by the potential purchaser.

4. The method of claim 3, further comprising the steps of:
(a) prompting the potential purchaser via the communications link to provide any information necessary to effect purchase of the product or service;
(b) receiving from the potential purchaser via the communications link the information necessary to effect purchase of the product or service; and
(c) transmitting the information necessary to effect purchase of the product or service to the supplier whose bid was accepted by the potential purchaser.

5. The method of claim 2, wherein the potential purchaser has selected the option of purchasing the product or service, further comprising the steps of:
(a) prompting the potential purchaser via the communications link to provide any information necessary to effect purchase of the product or service;
(b) receiving from the potential purchaser the information necessary to effect purchase of the product or service via the communications link; and
(c) transmitting the information necessary to effect purchase of the product or service to the supplier.

6. The method of claim 1, wherein the descriptive information about the product or service comprises a UPC, a manufacturer name, a model number, a model name, or a price.

7. The method of claim 1, wherein descriptive information about the product or service was entered into the user interface using optical character recognition, automatic speech recognition, a bar code scanner, or radio frequency identification.

8. The method of claim 1, wherein the comparison of the pricing and/or product or service information received from the supplier(s) is performed by a price comparison engine.

9. The method of claim 8, wherein the price comparison engine is located on an outsourced server.

10. The method of claim 1, wherein the wireless device comprises a cell phone, a personal digital assistant, or a wireless computer.

11. The method of claim 1, wherein the communications link comprises a wireless Internet connection, wireless data network, wireless voice network, or any wireless data or voice technology operable to receive the descriptive information about the product or service from the potential purchaser.

12. A system for providing a potential purchaser with real-time or near real-time pricing and/or product or service information and facilitating purchase of the product or service by the potential purchaser, comprising:
(a) means for communicating with a potential purchaser through a user interface residing on a wireless device via a communications link;
(b) means for identifying one or more suppliers offering the product or service for sale;
(c) means for communicating with the supplier(s) of the product or service;
(d) means for obtaining supplier-provided pricing and/or product or service information;
(e) means for comparing the pricing and/or product or service information received from the supplier(s);
(f) means for generating a price and/or product or service comparison result; and
(g) means for enabling the potential purchaser to purchase the product or service from one or more of the suppliers.

13. The system of claim 12, further comprising:
(a) means for providing one or more option(s) to the potential purchaser via the communications link, including an option to initiate a reverse auction of the product or service and/or an option to purchase the product or service, optionally including an option to transmit some or all of the information contained within the price and/or product or service comparison result to the potential purchaser, and optionally including an option to make a donation; and
(b) means for executing the option(s) selected by the potential purchaser.

14. The system of claim 13, further comprising means for initiating a reverse auction of the product or service involving one or more suppliers.

15. The system of claim 12, wherein the means for comparing the pricing and/or product or service information received from the supplier(s) comprises a price comparison engine.

16. The system of claim 15, further comprising means for communicating with the price comparison engine via a data transmission network, wherein the price comparison engine is located on an outsourced server.

17. The system of claim 12, wherein the wireless device comprises a cell phone, a personal digital assistant, or a wireless computer.

18. The system of claim 12, wherein the communications link comprises a wireless Internet connection, a wireless data network, a wireless voice network, or any wireless data or voice technology operable to receive the descriptive information about the product from the potential purchaser.

19. A method of transmitting real-time or near real-time pricing and/or product or service information to a potential purchaser and facilitating purchase of the product or service by the potential purchaser, comprising the steps of:
(a) receiving descriptive information about the product or service from a potential purchaser over a communications link via a user interface residing on a wireline device;
(b) identifying one or more suppliers offering the product or service for sale;
(c) obtaining pricing and/or product or service information from the supplier(s);
(d) comparing the pricing and/or product or service information obtained from the supplier(s);
(e) generating a price and/or product or service comparison result;
(f) transmitting the price and/or product or service comparison result to the potential purchaser via the communications link for display on the potential purchaser's user interface; and
(g) enabling the potential purchaser to purchase the product or service from any of the suppliers.

20. The method of claim 19, further comprising the steps of:
(a) transmitting one or more options to the potential purchaser via the communications link, including an option to initiate a reverse auction of the product or service and/or an option to purchase the product or service, optionally including an option to transmit some or all of the information contained within the price and/or product or service comparison result to the potential purchaser, and optionally including an option to make a donation; and
(b) optionally receiving a selection of one or more of the options from the potential purchaser via the communications link.

21. The method of claim 20, wherein the potential purchaser has selected the option of initiating a reverse auction, the reverse auction comprising the steps of:
(a) transmitting a request for bids to the supplier(s);
(b) receiving one or more bids from the supplier(s);
(c) transmitting the bid(s) to the potential purchaser via the communications link;
(d) receiving a purchase decision from the potential purchaser via the communications link accepting or declining any of the bids; and
(e) optionally transmitting the purchase decision to the supplier whose bid was accepted by the potential purchaser.

22. The method of claim 21, further comprising the steps of:
(a) prompting the potential purchaser via the communications link to provide any information necessary to effect purchase of the product or service;
(b) receiving from the potential purchaser via the communications link the information necessary to effect purchase of the product or service; and
(c) transmitting the information necessary to effect purchase of the product or service to the supplier whose bid was accepted by the potential purchaser.

23. The method of claim 20, wherein the potential purchaser has selected the option of purchasing the product or service, further comprising the steps of:
(a) prompting the potential purchaser via the communications link to provide any information necessary to effect purchase of the product or service;
(b) receiving from the potential purchaser the information necessary to effect purchase of the product or service via the communications link; and
(c) transmitting the information necessary to effect purchase of the product or service to the supplier.

24. The method of claim 19, wherein the descriptive information about the product or service comprises a UPC, a manufacturer name, a model number, a model name, or a price.

25. The method of claim 19, wherein descriptive information about the product or service was entered into the user interface using optical character recognition, automatic speech recognition, a bar code scanner, or radio frequency identification.

26. The method of claim 19, wherein the comparison of the pricing and/or product or service information received from the supplier(s) is performed by a price comparison engine.

27. The method of claim 26, wherein the price comparison engine is located on an outsourced server.

28. The method of claim 19, wherein the wireline device comprises a personal computer with an internet connection.

29. The method of claim 19, wherein the communications link comprises a wireline Internet connection, wireline data network, wireline voice network, or any wireline data or voice technology operable to receive the descriptive information about the product or service from the potential purchaser.

30. A system for providing a potential purchaser with real-time or near real-time pricing and or product or service information and facilitating purchase of the product or service by the potential purchaser, comprising:
(a) means for communicating with a potential purchaser through a user interface residing on a wireline device via a communications link;
(b) means for identifying one or more suppliers offering the product or service for sale;
(c) means for communicating with the supplier(s) of the product or service;
(d) means for obtaining supplier-provided pricing and/or product or service information;
(e) means for comparing the pricing and/or product or service information received from the supplier(s);
(f) means for generating a price and/or product or service comparison result; and
(g) means for enabling the potential purchaser to purchase the product or service from one or more of the suppliers.

31. The system of claim 30, further comprising:
(a) means for providing one or more option(s) to the potential purchaser via the communications link, including an option to initiate a reverse auction of the product or service and/or an option to purchase the product or service, optionally including an option to transmit some or all of the information contained within the price and/or product or service comparison result to the potential purchaser, and optionally including an option to make a donation; and
(b) means for executing the option(s) selected by the potential purchaser.

32. The system of claim 31, further comprising means for initiating a reverse auction of the product or service involving one or more suppliers.

33. The system of claim 30, wherein the means for comparing the pricing and/or product or service information received from the supplier(s) comprises a price comparison engine.

34. The system of claim 33, further comprising means for communicating with the price comparison engine via a data transmission network, wherein the price comparison engine is located on an outsourced server.

35. The system of claim 31, wherein the wireline device comprises a personal computer with an internet connection.

36. The system of claim 31, wherein the communications link comprises a wireline Internet connection, a wireline data network, a wireline voice network, or any wireline data or voice technology operable to receive the descriptive information about the product from the potential purchaser.

37. A method for conducting a reverse auction comprising the steps of:
(a) receiving, from a communications device used by a potential purchaser, a reverse auction request for a product and/or service containing descriptive information about the product and/or service;
(b) conducting a reverse auction by:
(i) querying one or more bidder database servers using the descriptive information about the product and/or service contained in the reverse auction request;
(ii) receiving one or more bids to sell the product and/or service from the one or more bidder database servers; and
(c) transmitting the one or more bids via a communications network to the communications device.

38. The method of claim 37, wherein the descriptive information about the product and/or service was entered into the reverse auction request using a reverse auction interface.

39. The method of claim 38, wherein the reverse auction interface is a graphical user interface.

40. The method of claim 38, wherein the reverse auction interface resides on the communications device.

41. The method of claim 37, wherein the descriptive information about the product and/or service was entered into the reverse auction request using optical character recognition.

42. The method of claim 37, wherein the descriptive information about the product and/or service was entered into the reverse auction request using automatic speech recognition.

43. The method of claim 37, wherein the descriptive information about the product and/or service was entered into the reverse auction request using a bar code scanner.

44. The method of claim 37, wherein the descriptive information about the product and/or service was entered into the reverse auction request using radio frequency identification.

45. The method of claim 37, wherein the communications network is a wireless network.

46. The method of claim 37, wherein the communications network is a wireless or wireline telephony network.

47. The method of claim 37, wherein the communications network is a wireless or wireline local area network.

48. The method of claim 37, wherein the communications network is a wireless or wireline Internet network.

49. The method of claim 37, wherein the communications device comprises a cell phone, smart phone, or personal digital assistant.

50. The method of claim 37, wherein the communications device comprises a personal computer that is connected to a wireless or wireline local area network or to a wireless or wireline Internet network.

51. The method of claim 37, wherein the descriptive information about the product and/or service comprises a make, model number, and/or bar code number.

52. The method of claim 37, wherein the at least one bidder database server is configured to:
(a) host a bidder interface that allows a bidder to input predetermined bid parameters; and
(b) automatically generate a bid based on the predetermined bid parameters.

53. The method of claim 52, wherein the bidder interface is further configured to allow the bidder to:
(a) opt in or opt out of a reverse auction based on the predetermined bid parameters;
(b) to apply a global discount to every product and/or service in a merchant's database;
(c) to apply a discount to a category of product and/or service in a merchant's database;
(d) to apply a discount to a product and/or service based on a stock keeping unit; and/or
(e) to apply a discount to the product and/or service based on volume of orders for the product and/or service over a predetermined period of time.

54. The method of claim 53, wherein the bidder interface allows the bidder to opt in or opt out of a reverse auction based on a type of product and/or service that is the subject of the reverse auction request.

55. The method of claim 52, wherein the bidder is allowed to enter the predetermined bid parameters into the bidder interface via an electronic form, automatic speech recognition, or optical character recognition.

56. The method of claim 37, wherein the one or more bids received from the bidder database server(s) are compared and compiled into a reverse auction result prior to transmission to the communications device, and wherein the one or more bids are transmitted to the communication device within the reverse auction result.

57. A method for conducting a reverse auction comprising the steps of:
(a) initiating the reverse auction by:
(i) composing, on a communications device, a reverse auction request for a product and/or service containing descriptive information about the product and/or service;
(ii) sending the reverse auction request to a system having a reverse auction server configured to conduct a reverse auction, wherein the reverse auction server:
(1) queries one or more bidder database servers using the descriptive information about the product and/or service contained in the reverse auction request;
(2) receives one or more bids to sell the product and/or service from the one or more bidder database servers; and
(3) transmits the one or more bids via a communications network to the communications device;
(b) receiving the one or more bids from the system on the communications device; and
(c) optionally purchasing the product and/or service or optionally having one or more of the bids transmitted to a SMS or e-mail address.

58. A system for conducting a reverse auction comprising a reverse auction server configured to:
(a) receive, from a communications device used by a potential purchaser, a reverse auction request for a product and/or service containing descriptive information about the product and/or service;
(b) conduct a reverse auction by:
(i) querying one or more bidder database servers using the descriptive information about the product and/or service contained in the reverse auction request;
(ii) receiving one or more bids to sell the product and/or service from the one or more bidder database servers; and
(c) transmit the one or more bids via a communications network to the communications device.

59. The system of claim 58, wherein the communications network is a wireless network.

60. The system of claim 58, wherein the communications network is a wireless or wireline telephony network.

61. The system of claim 58, wherein the communications network is a wireless or wireline local area network.

62. The system of claim 58, wherein the communications network is a wireless or wireline Internet network.

63. The system of claim 58, wherein the communications device comprises a cell phone, smart phone, or personal digital assistant.

64. The system of claim 58, wherein the communications device comprises a personal computer that is connected to a wireless or wireline local area network or to a wireless or wireline Internet network.

65. The system of claim 58, wherein the descriptive information about the product and/or service comprises a make, model number, and/or bar code number.

66. The system of claim 58, wherein the at least one bidder database server is configured to host a bidder interface that allows a bidder to opt in or opt out of a reverse auction based on predetermined parameters, to apply a global discount to every product and/or service in a merchant's database, to apply a discount to a category of product and/or service in a merchant's database, to apply a discount to a product and/or service based on a stock keeping unit, and/or to apply a discount to a product and/or service based on volume of orders for the product and/or service over a predetermined period of time.

67. The system of claim 66, wherein the bidder interface is configured to allow the bidder to opt in or opt out of a reverse auction based on a type of product and/or service that is the subject of the reverse auction request.

68. The system of claim 58, wherein the system is hosted by a wireless network operator or a third party auction intermediary.

69. The system of claim 58, wherein the system is configured to allow the potential purchaser to be identified and/or authenticated when the reverse auction server receives a reverse auction request from the potential purchaser.

70. The system of claim 58, wherein:
(a) the system is configured to allow the bidder to be identified and/or authenticated when the reverse auction server receives a bid from the bidder database server;
(b) all data stored on or transmitted by the reverse auction server is encrypted;
(c) the reverse auction server further comprises a firewall;
(d) administrative access to the reverse auction server is controlled by an administrative user identification and password combination; and/or
(e) administrative access to the reverse auction server is controlled by a physical key to computer hardware on which the reverse auction server resides.
